(19) United States
(12) Patent Application Publication
(10) Pub. No.: US 2019/0333143 A1
(43) Pub. Date: Oct. 31, 2019

(54) SYSTEM FOR ENABLING SHORT-TERM FINANCING

(71) Applicant: Darren Williams, London (GB)

(72) Inventor: Darren Williams, London (GB)

(21) Appl. No.: 15/966,351

(22) Filed: Apr. 30, 2018

(51) Int. Cl. G06Q 40/02; G06Q 20/06

(52) U.S. Cl. CPC G06Q 40/025; G06Q 20/065

(57) ABSTRACT

Small and medium sized enterprises are often in need of short-term financing, such as via invoice financing. However, peer-to-peer invoice financing platforms are vulnerable to fraud, and in particular duplication in the selling of invoices. The present invention allows the ledger of prior art blockchains to be decoupled to improve operational efficiency.

The present invention relates generally to a system and method for enabling short-term financing, and finds particular, although not exclusive, utility in invoice financing.

Small and medium sized enterprises (SMEs) are often in need of short-term financing especially when there is a sudden and immediate need for increased working capital to fund wages or the purchase of raw materials. Such SMEs will very often take out short-term loans from their bank or from newer, more innovative P2P (peer-to-peer) invoice finance platforms that have recently entered the industry. These P2P invoice financing platforms operate in the same manner as the traditional invoice financing companies by providing short term liquidity on invoices for short durations of up to 90 days. Rather than waiting for their customers to settle invoices that have due dates of 45 to 90 days, an SME may sell their invoices to invoice financing companies to access “immediate” funds. P2P platforms are unique in that they connect invoice sellers directly with invoice buyers making the rise of P2P as an alternative lending platform more attractive to businesses globally.

However, P2P invoice financing platforms are vulnerable to fraud, and in particular duplication in the selling of invoices, that the present invention seeks to mitigate.

According to a first aspect of the present invention, there is provided a system for enabling short-term financing, the system comprising: an external tokens module for implementing a smart contract on a contract blockchain; stable crypto-currency tokens for transferring value between sellers and buyers, the stable crypto-currency tokens managed on respective currency blockchains; a centrally administered ledger configured to keep an active log of buyer's and seller's transactions of the stable crypto-currency tokens in accordance with the smart contract; a public distributed ledger to which the centrally administered ledger is logged after each transaction between a buyer and a seller of the stable crypto-currency tokens in accordance with the smart contract; and a ledger blockchain storing a hash of the public distributed ledger in response to logging of the centrally administered ledger to the public distributed ledger.

In this way, the ledger of prior art blockchains is decoupled to improve operational efficiency.

The external tokens module may be for governing how tokens may be transferred between addresses and how data within each token may be accessed.

The external token module may conform to the Ethereum ERC20 token standard, but with parts of the functionality are restricted (e.g. minting and destruction of tokens). Each currency supported by the platform may have a corresponding smart contract, which implements the Ethereum ERC20 token standard.

Clients can withdrawal their funds outside the platform into these smart contracts, to gain sovereign access to their tokens.

The stable crypto-currency token may be a fiat-pegged crypto-currency. For example, the value of 1 stable crypto-currency token may be equivalent to 1 GBP. In this way, the currency exchange may also be decoupled from the blockchain to improve operational efficiency.

In this way, operation on the Ethereum Blockchain may be allowed while avoiding the direct usage of Ethereum and associated volatility of the Ethereum/Ether currency.

Stable crypto-currency tokens can be exchanged for fiat currencies or vice versa (subject to exchange rates) or the well-established cryptocurrencies such as Bitcoin and Ethereum, and withdrawn from the platform. Stable crypto-currency tokens are similar to any other crypto-currency and may be withdrawn from the platform as an ERC20 token to external Ethereum based wallet.

When a deposited is made the same amount of Stable crypto-currency token is minted and the Stable crypto-currency token amount shown in the account balance.

The centrally administered ledger may comprise an internal data entry. The centrally administered ledger may be configured to keep an active log of buyer's and seller's transactions of stable crypto-currency tokens such as for example bidding, exchanging, balance, collateralisation.

The public distributed ledger may be on for example the n InterPlanetary File System (IPFS) to which the centrally administered ledger is logged after each transaction.

The transparency of events along the supply chain via the Blockchain is itself a major enabler of faster payments and improved financing, increased efficiency, reduced risk of fraud, and lower costs. Exchanging information related to these events in a distributed ledger facilitates trigger events that need to take place for goods to arrive at their final destination and for suppliers to receive payment. But the capability of the Blockchain to facilitate these trigger events does not end with the mere exchange of information along a supply chain.

Smart contracts are self-executing computer codes that automatically carry out functions once a triggering event has taken place. It is a linear contract that can include multiple parties (investors, borrowers, buyers, sellers etc.) and that cannot be altered.

With a smart contract, legal stipulations are embedded in the computer code, which enables the automatic execution of functions defined by a legal contract. It also provides protection against duplicate invoice financing, as the contract will not allow for an invoice that has already been financed to receive additional financing. A smart contract, therefore, acts as an application layer that is built on the Blockchain.

In this way, smart contracts may be used to not only trigger events but actually carry them out automatically.

For example, if a smart contract is written between an invoice seller and an invoice buyer to say that once the invoice buyer is approved, 80% of the funds will be released from the buyer to the invoice seller, a smart contract would automatically disburse payment once confirmation is entered into a distributed ledger that the buyer is approved (such as by winning a bid, auction or crowd funding scenario). The approval is not a triggering event requiring action by a bank; the payment is automatically made once confirmation has been entered into the system.

The system and/or any components thereof may comprise at least one computing device, at least one computer program and/or computer program code. For instance, it and/or they may be embodied in software. In particular the or each computer program may be run on the at least one computing device and/or the or each computer program may comprise the computer program code. The system may comprise at least one computer-readable-medium having non-transitory software instructions stored therein. The ledger(s) may be stored on at least one computer-readable memory.

According to a second aspect of the present invention, there is provided a method for enabling short-term financing, the method comprising the steps of: implementing a smart contract on a contract blockchain; managing stable crypto-currency tokens on respective currency blockchains; keeping an active log of buyer's and seller's transactions of the stable crypto-currency tokens in accordance with the smart contract on a centrally administered ledger; performing a transaction between a buyer and a seller of the stable crypto-currency tokens in accordance with the smart contract; logging the centrally administered ledger to a public distributed ledger in response to performing the transaction; and storing a hash of the public distributed ledger on a ledger blockchain in response to logging of the centrally administered ledger to the public distributed ledger.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

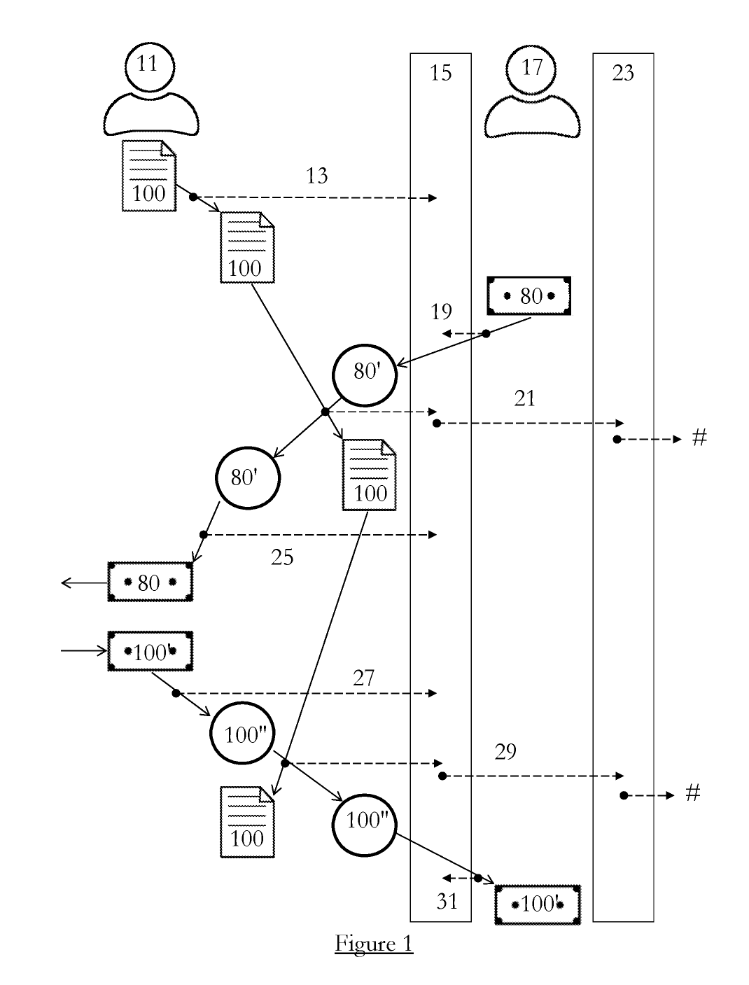

FIG. 1 shows transactions within a system and method for enabling short-term financing.

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are not in direct contact with each other but yet still co-operate or interact with each other.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

FIG. 1 shows transactions within a system and method for enabling short-term financing. An invoice seller 11 has an invoice 100 (having value of 100 units) which it registers 13 with the system; this event 13 is recorded on the centrally administered ledger 15. An invoice buyer 17 agrees to buy the invoice 100 for a value of 80 units, and converts fiat currency 80 into stable crypto-currency tokens 80; this event 19 is also recorded on the centrally administered ledger 15.

The system carries out a transaction between the seller 11 and the buyer 17 by exchanging ownership of the invoice 100 and stable crypto-currency tokens 80′; this event 21 is recorded on the centrally administered ledger 15, and logged on the public distributed ledger 23 and a hash is stored of the public distributed ledger on a ledger blockchain #.

The seller can now convert the stable crypto-currency tokens 80′ back into fiat currency 80 for whatever purpose was required; this event 25 is recorded on the centrally administered ledger 15.

At a later date, once the invoice seller 11 has received payment 100′ for the invoice 100, that payment 100′ may be converted into stable crypto-currency tokens 80″; this event 27 is recorded on the centrally administered ledger 15. In response, the system automatically carries out a further transaction between the seller 11 and the buyer 17 by exchanging ownership of the invoice 100 and stable crypto-currency tokens 100″; this event 29 is recorded on the centrally administered ledger 15, and logged on the public distributed ledger 23 and a hash is stored of the public distributed ledger on a ledger blockchain #.

Finally, the buyer can now convert the stable crypto-currency tokens 100″ back into fiat currency 100′ for a profit; this event 31 is recorded on the centrally administered ledger 15.

1. A system for enabling short-term financing, the system comprising:
an external tokens module for implementing a smart contract on a contract blockchain;
stable crypto-currency tokens for transferring value between sellers and buyers, the stable crypto-currency tokens managed on respective currency blockchains;
a centrally administered ledger configured to keep an active log of buyer's and seller's transactions of the stable crypto-currency tokens in accordance with the smart contract;
a public distributed ledger to which the centrally administered ledger is logged after each transaction between a buyer and a seller of the stable crypto-currency tokens in accordance with the smart contract; and
a ledger blockchain storing a hash of the public distributed ledger in response to logging of the centrally administered ledger to the public distributed ledger.

2. A method for enabling short-term financing, the method comprising the steps of:
implementing a smart contract on a contract blockchain;
managing stable crypto-currency tokens on respective currency blockchains;
keeping an active log of buyer's and seller's transactions of the stable crypto-currency tokens in accordance with the smart contract on a centrally administered ledger;
performing a transaction between a buyer and a seller of the stable crypto-currency tokens in accordance with the smart contract;
logging the centrally administered ledger to a public distributed ledger in response to performing the transaction; and
storing a hash of the public distributed ledger on a ledger blockchain in response to logging of the centrally administered ledger to the public distributed ledger.
